(19) United States
(12) Patent Application Publication
(10) Pub. No.: US 2012/0126546 A1
(43) Pub. Date: May 24, 2012

(54) ELECTRICITY-GENERATING UNIT AND ELECTRICAL MOTOR VEHICLE

(76) Inventor: Gerhard Walter Auer, Graz (AT)

(21) Appl. No.: 13/388,085

(22) PCT Filed: Aug. 4, 2009
(86) PCT No.: PCT/AT2009/000298

§ 371 Date: Jan. 31, 2012

(51) Int. Cl. H02K 7/18; F02D 29/06

(52) U.S. Cl. 290/1 C; 290/7; 180/65.245; 903/903

(57) ABSTRACT

The aim of the invention is to produce an electricity-producing unit that enables a motor vehicle of any conceivable design to be equipped with said invention and thus to produce a motor vehicle that is driven purely by one or more electric motors, wherein the electricity-generating unit works pollutant-free during operation, is environmentally friendly, generates little noise, and has a very small design. Said aim is achieved by a drive system comprising a turbine (1/1), a differential gear (1/2), a generator (1/3), a control unit (1/4), and a starter (1/5), wherein only electric motors are provided to drive the wheels of the motor vehicle.

The invention relates to a power-generating unit for use in motor vehicles of any design as well as to an electric motor vehicle. Motor vehicles of this type are known, in which context, for example, patent 43 41 569 A1 (Programme 3 Patent Holdings) is showing a drive system for a road vehicle, which includes a turbine and a generator. However, in this case, the generator is arranged on a shaft jointly with the turbine, the generator having a design speed which is the same as that of the turbine. Separate control of the turbine and the generator is thus not possible. Optimal operation with regard to output requirements and efficiency cannot be attained in this instance. In DE 100 33 736 A1 (Preu) as well, a generator is fitted on the turbine shaft. In this case, the optimal, simultaneous operation of turbine and generator can thus likewise not be attained. Published patent DE 19 41 503 A1 (Plishner) likewise shows a vehicle, wherein the generator and the turbine are arranged on a shaft, thus providing no possibility of control. In DE 41 09 379 A1 (AVL) as well, the internal combustion engine drives the generator via its shaft. In this case, the internal combustion engine is designed to have an optimal operating point, as a result of which the generator coupled thereto can never be operated at its optimal efficiency. In DE 43 10 001 A1 (Herf) a drive module, not defined in detail, is provided, transmitting the energy to individual drive means. A turbine or generator is not mentioned in this particular case. DE 10 2004 038 919 A1 (Ford) describes a hybrid drive system, wherein, optionally, a conventional internal combustion engine or an electric motor is used.

It is the object of the invention to produce a power-producing unit that enables a motor vehicle of any conceivable design to be equipped therewith and thus to produce a motor vehicle that is driven entirely by one or even a plurality of electric motors, wherein the power-generating unit works in a non-polluting manner during operation, is environmentally-friendly, generates little noise and is at the same time designed to have very small dimensions. Only by way of this invention does it become possible to use an electric motor vehicle, which has the same capabilities as a motor vehicle with a spark ignition engine, except that instead of the spark ignition engine or the diesel engine one or a plurality of electric motors are used, which ensure that the driver is afforded the same driving comfort and also allows him unimpaired driving mode as well as to travel distances, which conventional electric vehicles are unable to cover (e.g. mountain drives, transporting heavy loads in rough terrain, covering long distances without having to change batteries or being subjected to stop periods for hours). Only by way of this invention does it become possible to fully use an electric vehicle and to also use it anywhere.

The object according to the invention is attained in that a turbine is operated with a methanol—water mixture or an ethanol—water mixture, having an output of 10 HP to 1000 HP, which, by means of a step-down gear, drives a generator having an output of 10 KW to 1000 KW, thus supplying the electric motor or the electric motors with power directly or by means of a buffer storage battery. A suitable turbine with an injection system is described in EP 1319816. The power-generating unit must ensure that the electric motor(s) receive(s) sufficient power via the buffer storage battery or directly and, consequently, ensure a continuous driving mode, which is performance-related. This requirement is met in that the turbine operates in an impulse-controlled manner and can thus be switched on and off at any time, thus producing power only when the command is issued by the control unit. The buffer storage battery is constantly controlled and checked by the control unit with regard to performance. This communication also takes place with the electric motor or the electric motors. The entire power expenditure is regulated and evaluated via a monitoring-control system which is computer-controlled. This evaluation is constantly fed into the display in the cockpit. The design of the generator is so selected that the power-generating unit requires no transformer. However, should one be required, the transformer is then connected between the generator and the buffer storage battery. For various motor vehicle types a buffer storage battery can be dispensed with; only a conventional battery is required which activates the electric starter for the turbine and which maintains the entire computer-controlled power demand. This operation of the power-generating unit makes it possible to equip any type of motor vehicle (passenger cars, trucks, construction machinery as well as trains) with said power-generating unit, thereby ensuring unrestricted driving mode. The vehicle-integrated tank for the fuel, methanol, ethanol as well as a methanol—water mixture or ethanol—water mixture, being of a size accommodating between 10 liters and 500 liters, in trains up to 5000 liters, allows any design of motor vehicle to be operated independently and without any restrictions. The turbine operates in a pollution-free manner.

The advantage of this invention is to provide a power-generating unit for all motor vehicles and to thereby ensure a purely electrical driving mode. The advantage, in contrast to other electric vehicles and hybrid vehicles, is the fact that this invention ensures entirely electrical driving mode in any situation and condition as well as under any geographical conditions (mountains), which, at present, cannot be accomplished by any conventional electric vehicle or hybrid vehicle. There will never be a power bottleneck, since continuous power supply, for which the control system is responsible, is ensured at all times. Due to the fuel used, the operation of the turbine takes place in a non-polluting manner and can thus be employed anywhere without any restrictions. Every known hybrid vehicle is not pollution-free and is not a purely electric vehicle either. The purely electric vehicle can only be used by making use of the present invention, as the power is produced on-board. Electric, battery-operated vehicles have a restricted range and the reserves are immediately used up under load or in the event of mountain drives. Replacing or charging the battery is unavoidable.

### LEGEND

1 . . . Power-generating unit
2 . . . Electric motor (all suitable, currently commercially-available motors of electric design)
3 . . . Transformer
4 . . . Control unit
5 . . . Battery 12 V
6 . . . Buffer storage battery
7 . . . Transmission
8 . . . Fuel tank
9 . . . Differential gear
1/1 . . . Turbine
1/2 . . . Differential gear
1/3 . . . Generator
1/4 . . . Control unit
1/5 . . . Starter

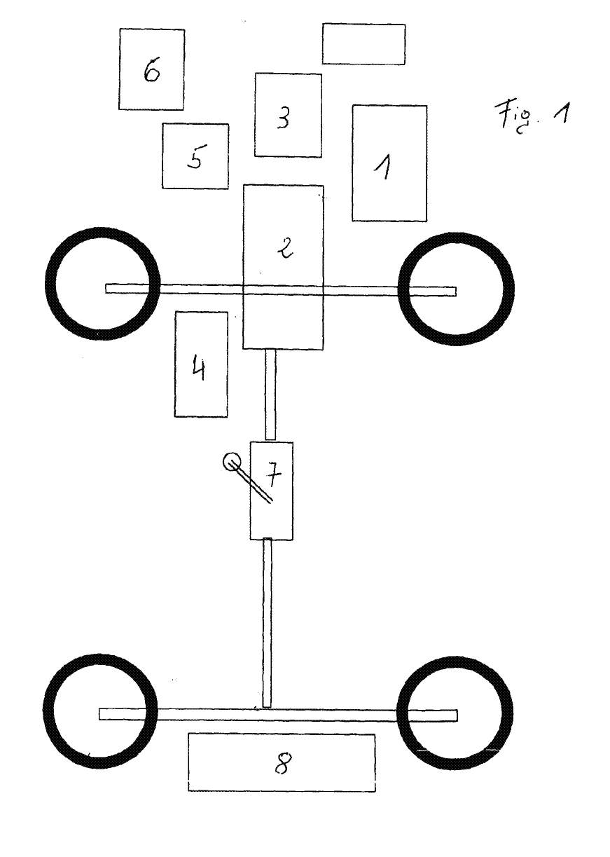

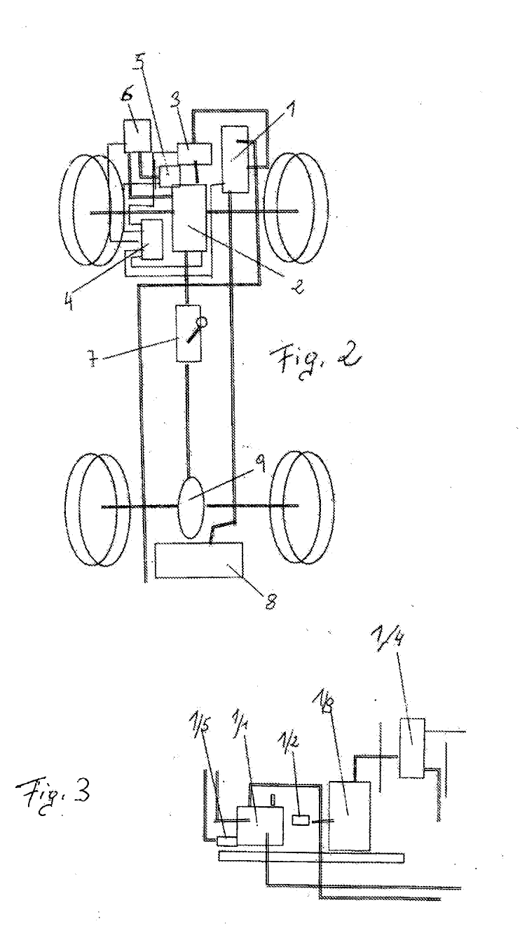

FIG. 1 and FIG. 2, respectively, show an electric vehicle according to the invention, wherein a power-generating unit 1 is provided. The power generated passes by way of a transformer 3 and a buffer storage battery 6 to the electric motor 2, which may have a voltage ranging from 6V to 24V or 100 volt up to 440 volt, this procedure being very strictly monitored (?) [text missing] by using the control unit 4, which monitors and controls the optimal power consumption as well as the optimal power generation by the generator 1/3 in order to supply the electric motor 2 with the correct voltage and frequency having a Hertz rate of 50 Hz-60 Hz and to thereby provide an electric motor vehicle which is environmentally-friendly, independent, able to cover unlimited distances and requires no heavy battery blocks (360 kg). The electric vehicle is in this context driven by two electric motors 2, the output of the motors 2 of 10 HP and higher being unlimited (trains, etc.). It may also be equipped with four electric motors 2, namely one at each wheel, each of these motors 2 having an output of 1 HP, or upwardly unlimited, and the said motors 2 being brought to optimal load by the control system 4.

The power-generating unit according to the invention is shown in FIG. 3 and consists of a turbine 1/1, a differential gear 1/2, a generator 1/3, a control unit 1/4 and a starter 1/5, a methanol—water mixture or an ethanol—water mixture being used as a fuel, thus emitting no pollutants and ensuring a pollution-free operation of this unit 1, the turbine 1/1 driving the generator 1/3 via a differential gear 1/2.

1. Power-generating unit for use in any type of motor vehicle, the power-generating unit (1) consisting of a drive system, for example a turbine (1/1), a differential gear (1/2), a generator (1/3), a control unit (1/4) and a starter (1/5), characterized in that the drive system, for example, the turbine (1/1), drives the generator (1/3) by means of a differential gear (1/2) and that the power generated thereby passes to an electric motor (2), driving the motor vehicle.

2. Power-generating unit according to claim 1, characterized in that the electric motor has a voltage ranging from 6V to 24 V.

3. Power-generating unit according to claim 1, characterized in that the electric motor has a voltage ranging from 100 volt to 440 volt.

4. Power-generating unit according to claim 3, characterized in that the electric motor has a frequency of 50Hz-60 Hz.

5. Power-generating unit according to anyone of claims 1 to 4, characterized in that the control unit (1/4) monitors and controls the optimal power consumption as well as the optimal power generation by the generator (1/3).

6. Power-generating unit according to anyone of claims 1 to 5, characterized in that the power generated passes to the electric motor (2) by way of a transformer (3) and a buffer storage battery (6).

7. Power-generating unit according to anyone of claims 1 to 6, characterized in that the drive system consists of a spark ignition engine, a diesel engine, a Wankel engine or a gas turbine.

8. Power-generating unit according to claim 7, characterized in that the drive system is operated with petrol, diesel, gas, bio gas.

9. Electric motor vehicle. characterized in that it includes a power-generating unit (1), consisting of a drive system, for example a turbine (1/1), a differential gear (1/2), a generator (1/3), a control unit (1/4) and a starter (1/5), the said drive system, for example, the turbine (1/1), driving the generator (1/3) by means of a differential gear (1/2), the power generated thereby passing to an electric motor (2) driving the motor vehicle.

10. Electric motor vehicle according to claim 9, characterized in that the electric motor vehicle is driven by two electric motors (2), the output of the motors (2) exceeding 7.36 kW (10 HP).

11. Electric motor vehicle according to claim 9, characterized in that the electric motor vehicle is driven by four electric motors (2), provided, in particular, on each wheel, that each of these motors (2) has an output of at least 0.736 kW (1 HP) and is brought to an optimal load condition by means of the control system (1/4).

12. Electric motor vehicle according to any one of claims 9 to 11, characterized in that the motor vehicle comprises one or a plurality of electric circuits and that the power for the control unit (1/4) is produced by means of an electric generator with a voltage ranging from 6V to 24V and that the power for the electric motor(s) (2) has a voltage of 100 volt to 440 volt at 50-60 Hz.
